(19) United States
(12) Patent Application Publication
(10) Pub. No.: US 2024/0192920 A1
(43) Pub. Date: Jun. 13, 2024

(54) Special Purpose Integrated Circuits and Methods for Matrix Multiplication Using Only Addition

(71) Applicant: Daniel Cussen, Santiago (CL)

(72) Inventor: Daniel Cussen, Santiago (CL)

(21) Appl. No.: 18/520,347

(22) Filed: Nov. 27, 2023

Related U.S. Application Data
(60) Provisional application No. 63/429,920, filed on Dec. 2, 2022.
(60) Provisional application No. 63/440,235, filed on Jan. 20, 2023.

(51) Int. Cl. G06F 7/501; G06F 7/57

(52) U.S. Cl. CPC G06F 7/501; G06F 7/57

(57) ABSTRACT

Special purpose integrated circuits and methods for matrix multiplication are disclosed. In some embodiments, a special purpose integrated circuit is constructed to perform mathematical operations. For matrix A and matrix B, an outer product of each column i of matrix A [vector Ai] and a corresponding row i of matrix B [vector Bi], for all i, is used to calculate all the products used for determining matrices A and B. A product matrix C (where A×B=C) is assembled using additions of the elements of the calculated outer products. Each outer product of Ai and Bi may be calculated using a series of vector-scalar products. Each vector-scalar product is calculated using the vector Bi and a selected element of Ai as the scalar. Thus, calculating the vector-scalar product for all the elements of Ai will produce the outer product of Ai and Bi.

### CROSS-REFERENCE TO RELATED APPLICATIONS

This application claims the benefit and priority of U.S. Provisional Patent Application Ser. No. 63/429,920, filed on Dec. 2, 2022, entitled “Matrix Multiplication Using Only Addition,” and U.S. Provisional Patent Application Ser. No. 63/440,235, filed on Jan. 20, 2023, entitled “Matrix Multiplication Using Only Addition,” all of which are hereby incorporated by reference herein in their entirety, including all appendices and references cited therein, for all purposes.

### FIELD

The present disclosure pertains to matrix multiplication using only addition, and more specifically, but not by way of limitation, to special purpose integrated circuits and methods for implementing vector-scalar multiplications between a vector and a scalar.

### SUMMARY

Matrix multiplication using only addition is described herein. Some embodiments provide a special purpose integrated circuit for implementing vector-scalar multiplications between a vector and a scalar. The special purpose integrated circuit is constructed to perform mathematical operations. The mathematical operations include step a) sorting a vector V having values [v1; : : : ; vn] to create a sorted vector S having values [s1; : : : ; sn] such that s1≤s2≤_ _ _≤sn. The mathematical operations also include step b) eliminating duplicate values to reduce the sorted vector S to [s1; : : : ; sm] such that s1<s2<_ _ _<sm, m being less than or equal to n. The mathematical operations continue with step c) creating a new array of pointers [p1; : : : ; pn] where pi is a unique value j such that vi=sj. The mathematical operations further include step d) calculating d1=s1 and di=si−si−1 for i=2; 3; : : :m to construct a new difference vector D having values [d1; : : : ; dm] of the differences between adjacent elements of the sorted vector S. The mathematical operations also include step e) constructing another new vector V and setting values [v1; : : : ; vn] of the another new vector V to [d1; : : : ; dm] of the difference vector D. The mathematical operations continue with step f) in which steps a) through e) are performed recursively until m is less than a desired threshold. The mathematical operations include step g) using Russian-Peasants multiplication of the difference vector D and a scalar c to produce a scalar product vector C having values [cd1; : : : ; cdm]. The mathematical operations also include step h) calculating cs1=cd1 and csi=csi−1+cdi for i=2; 3; : : : ; m using the scalar c and vector S having values [s1; : : : ; sm] to construct a product vector G having values [cs1; :: : ; csm]. The mathematical operations further include step j) copying the value csj from the product vector G to cvi using the pointer array [p1; : : : ; pn] for the current level of recursion, a pointer pi for that recursion level being that j such that vi=sj for each vi, and such that cvi=csj. The mathematical operations also include step k) repeating steps h) through j) for each level of recursion.

Implementations may include one or more of the following features. One general aspect includes a method for implementing vector-scalar multiplications between a vector and a scalar. The method includes step a) sorting, by a special purpose integrated circuit, a vector V having values [v1; : : : ; vn] to create a sorted vector S having values [s1; : : : ; sn] such that s1≤s2≤_ _ _≤sn. The method also includes step b) eliminating, by the special purpose integrated circuit, duplicate values to reduce the sorted vector S to [s1; : : : ; sm] such that s1<s2<_ _ _<sm, m being less than or equal to n. The method continues with step c) creating, by the special purpose integrated circuit, a new array of pointers [p1; : : : ; pn] where pi is a unique value j such that vi=sj. The method further includes step d) calculating, by the special purpose integrated circuit, d1=s1 and di=si−si−1 for i=2; 3; : : :m to construct a new difference vector D having values [d1; : : : ; dm] of the differences between adjacent elements of the sorted vector S. The method also includes step e) constructing, by the special purpose integrated circuit, another new vector V and setting values [v1; : : : ; vn] of the another new vector V to [d1; : : : ; dm] of the difference vector D. The method continues with step f) in which steps a) through e) are performed recursively until m is less than a desired threshold. The method includes step g) using Russian-Peasants multiplication, by the special purpose integrated circuit, of the difference vector D and a scalar c to produce a scalar product vector C having values [cd1; : : : ; cdm]. The method also includes step h) calculating, by the special purpose integrated circuit, cs1=cd1 and csi=csi−1+cdi for i=2; 3; : : : ; m using the scalar c and vector S having values [s1; : : : ; sm] to construct a product vector G having values [cs1; : : : ; csm]. The method further includes step j) copying, by the special purpose integrated circuit, the value csj from the product vector G to cvi using the pointer array [p1; : : : ; pn] for the current level of recursion, a pointer pi for that recursion level being that j such that vi=sj for each vi, and such that cvi=csj. The method also includes step k) repeating steps h) through j) for each level of recursion. Other embodiments of this aspect include corresponding computer systems, apparatus, and computer programs recorded on one or more computer storage devices, each configured to perform the actions of the methods. Further, implementations of the described techniques may include hardware, a further method or process, or computer software on a computer-accessible medium.

### BRIEF DESCRIPTION OF THE DRAWINGS

Exemplary embodiments are illustrated by way of example and not limited by the figures of the accompanying drawings, in which references indicate similar elements.

FIG. 1 depicts an outline of a vector-scalar multiplication algorithm, in accordance with some embodiments of the present disclosure.

FIG. 2 is a table of exemplary experimental results regarding vector-scalar multiplication, in accordance with some embodiments of the present disclosure.

FIG. 3 is a flowchart of an example method of the present disclosure.

FIG. 4 is a schematic diagram of an example computer system that can be used to implement embodiments of the present disclosure.

### DETAILED DESCRIPTION OF EXAMPLE EMBODIMENTS

### Overview

Matrix multiplication can be used in many technical and practical applications. For instance, matrix multiplication can be extremely useful in technical areas, including but not limited to, computer graphics, machine learning, cryptography, robotics, and image processing. However, there are significant trade-offs and limitations using traditional technologies and techniques of matrix multiplication. To date, traditionally for computing systems, matrix multiplication requires both a set of space-consuming multiplier chips and significant periods of time to process and complete matrix multiplication. Furthermore, if the matrices are large, the running time for processing and completing matrix multiplication using traditional methods can be longer than what is desired.

The special purpose integrated circuits, methods and systems disclosed herein offer a pragmatic approach to the challenges associated with traditional matrix multiplication algorithms used in computing systems. Specifically, the present disclosure provides for a single matrix-multiplier chip that can quickly perform matrix multiplication without a scalar multiplier circuit. In some embodiments, only a single addition and a single on-chip copy operation are needed to replace a matrix multiplication. Thus, the present disclosure describes an approach to replace the multiplication of mantissas, which are integers, by integer addition.

Embodiments provided in the present disclosure offer techniques of matrix multiplication using only addition. That is, when multiplying matrices, scalar multiplication is not needed and can be replaced by a surprisingly small number of additions. The advantage of performing matrix multiplication using only addition for arithmetic is that it then becomes feasible to build special purpose integrated chips without a multiplication unit. Such chips will take up less space per on-chip processor, allowing more, but simpler, processors to be packed into a single chip. In some embodiments, the special purpose integrated chip only requires a single adder.

As a result, the present disclosure offers a technological improvement in the form of a single matrix-multiplier chip that can perform these mathematical operations far more efficiently than traditional space-consuming multiplier chips. Since a multiplier circuit can take significantly more time than addition or other typical machine operations, the addition-only approach can be faster, even in conventional architectures. The present disclosure will also describe how in most practical applications, one of the many advantages of this technological solution is that very few additions (e.g., three or less additions) are needed to replace a multiplication. In contrast, integer multiplication takes 3-6 times as much time as integer addition.

Hence, the present disclosure offers a new approach to matrix multiplication that has further technical advantages over traditional means. One advantage is that this approach works for both sparse and dense matrices. Also, the approach is efficient when the matrices at issue are much larger. Further, this new approach works better when the specific matrix elements are short, which is an important trend as scientific experts search for ways to make machine learning more efficient. Further, the new approach described herein supports a chip design that omits a multiplication circuit, thus saving chip real estate. In other words, the new approach allows for more processors to be placed on one chip. Finally, the new approach uses a very small number of additions in place of one scalar multiplication, which in turn offers an opportunity to speed up the computation, since multiplication can take significantly more time than addition. These and other features of the present disclosure are set forth herein.

### EXAMPLE EMBODIMENTS

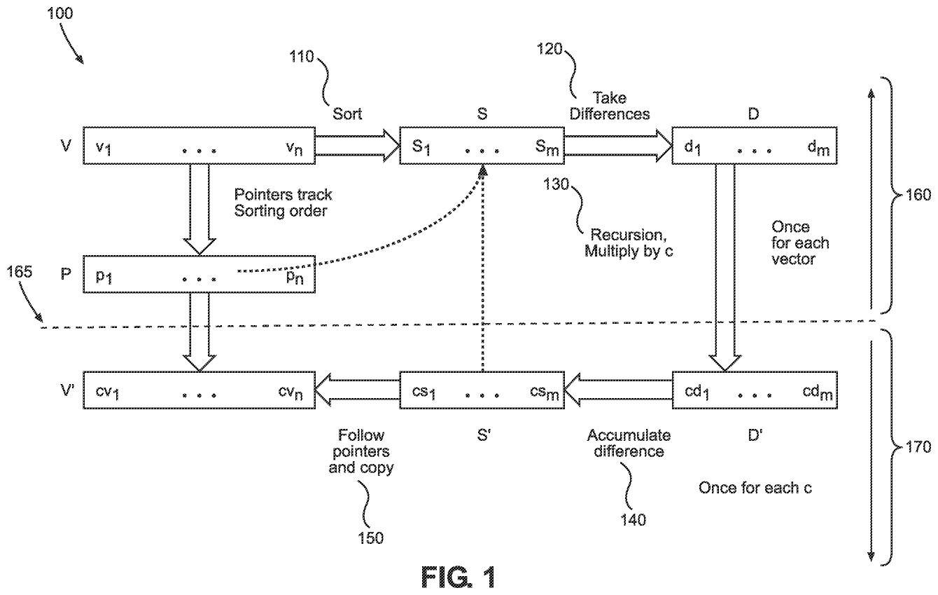

FIG. 1 depicts an outline of a vector-scalar multiplication algorithm 100, for multiplying a vector [v₁, . . . , vₙ] by a scalar c. An assumption is made that each vᵢ is a positive b-bit integer. Signed integers are handled by ignoring the sign until the products are created. The algorithm is recursive, in that it modifies the initial vector to produce a shorter vector [d₁, . . . , dₘ]. Not only is the vector shorter, but the sum of its elements is at most 2^{b}. This constraint is much stronger than the constraint on the original vector—that each element be less than 2*b.

Either using Russian-Peasants multiplication as a base case, or by applying the same ideas recursively, the vector-scalar product [cd1, . . . , cdₘ] is produced, to produce the desired output [cv1, . . . , cvₙ].

For matrix A and matrix B, an outer product of each column i of matrix A [vector Ai] and a corresponding row i of matrix B [vector Bi], for all i, may be used to calculate all the products used for determining matrices A and B. A product matrix C (where A×B=C) may then be assembled using additions of the elements of the calculated outer products.

Each outer product of Ai and Bi may be calculated using a series of vector-scalar products. Each vector-scalar product may be calculated using the vector Bi and a selected element of Ai as the scalar. Thus, calculating the vector-scalar product for all the elements of Ai may be used to produce the outer product of Ai and Bi.

For a selected element of Ai, a vector-scalar product may be calculated for the vector Bi, having values [v1; : : : ; vn] and a scalar c set to the selected element of vector Ai, using only addition according to the following algorithm:
1. Sort (depicted as Step 110 of FIG. 1):
   a) Sort the vector having values [v1; : : : ; vn] to create a sorted vector S having values [s₁; : : : ; sn] such that s1≤s2≤_ _ _≤sn
   b) Eliminate duplicates to reduce sorted vector to [s1; : : : ; sm] such that s1<s2<_ _ _<sm, m being less than or equal to n
   c) create a new array of pointers [p1; : : : ; pn] where pi gives the unique value j such that vi=sj.
2. Take the differences (depicted as Step 120 of FIG. 1):
   a) Construct a new vector [d1; : : : ; dm] giving the differences between successive elements of the sorted array. That is, d1=s1 and di=si−si−1 for i=2; 3; : : :m.
3. Recursion and multiplication (depicted as Step 130 of FIG. 1):
   a) construct a new vector setting values [v1; : : : ; vn] to [d1; : : : ; dm] and perform steps 1 and 2 recursively until m is less than a desired threshold.
   In some embodiments, the threshold is met when the vector is of a size equal or smaller than the corresponding dimension of an array of multipliers that perform the outer product with Russian peasant's multiplication explicitly. This particular size may be more than 24×24 and this array of multipliers can serve many reduction circuits on the same chip.
   In some further embodiments, the threshold is 4 or less.
   And
   b) Using Russian-Peasants multiplication, which is performed using only addition, produce a vector-scalar product [cd1; : : : ; cdm] 150, where c is the selected element of vector Ai.
4. Accumulate (depicted as Step 140 of FIG. 1):
   Compute the product of c and the vector [s1; : : : ; sm] by
   cs1=cd1 and csi=csi−1+cdi for i=2; 3; : : : ; m.
5. Follow Pointers recursively (depicted as Step 150 of FIG. 1):
   a) At each level of recursion, use the pointer pi for that level is that j such that vi=sj for each vi of that level. Therefore, cvi=csj for that level.
   b) copy the value csj as indicated at step 5(a) and make that be cvi.
   c) repeat steps 4 and 5 for each level of recursion.

Several important observations of the running time of the vector-scalar multiplication algorithm introduced in FIG. 1 can be noted. FIG. 1 represents two different phases, a first phase 160 and a second phase 170. The first phase 160, which is a phase depicted above a line 165 in FIG. 1, is done once for each row of the second matrix, i.e., n times. Thus, even a list of length n is sorted, which takes O(n log n) time, the total time spent above the line 165 in FIG. 1 is O(n² log n). That cost can be neglected, when compared with the O(n³) running time of the entire algorithm. However, in terms of chip design, the chip must have the capability of sorting and setting up the pointer array that is discussed earlier in relation to FIG. 1.

For the second phase 170, the operations that are depicted below the line 165 in FIG. 1 take O(n) time. The constant factor includes the number of additions needed to replace one multiplication. For each of the n rows of the second matrix, the operations below the line 165 are performed n times, so the total time taken is O(n³).

For purposes of describing this analysis of running time, serial execution has been assumed, which is neither realistic nor desirable for a special-purpose integrated chip. Although serial execution can be done, it is more advantageous, in order to maximize running time efficiencies, to design a special-purpose integrated chip for parallel execution (that is, for implementing a parallel sort or processing several vector-scalar multiplications at the same).

In further embodiments, a number of improvements or modifications can be implemented to the vector-scalar multiplication algorithm depicted in FIG. 1.

First, alignment can be used as a technique to reduce the length of vectors involved. If elements v and w of a vector differ by a factor that is a power of 2, then when the vector is multiplied by any constant c, the products cv and cw will also have a ratio that is the same power of 2. Therefore, cw can be obtained from cv, or vice-versa, by shifting their binary representations. This observation can be used to treat v and w as if they were the same, if modifications to the basic algorithm depicted in FIG. 1. Specifically, the technique of alignment is set forth as follows:
1. Before sorting [v1, . . . , vn], shift each element vᵢ right until it becomes an odd number (i.e., drop 0's from the lower-order bits).
2. In addition to the vector of pointers [p1, . . . , pn], another vector H=[h₁, . . . , hₙ] is needed, where hi is the number of positions to the right that we have shifted vᵢ.
3. When constructing the result vector [cv1, . . . , cvₙ], we construct cvi by first following the pointer pi and then shifting the result hi positions to the left. Alternatively, if we can shift and add in one step, we can perform this shifting when we add cvᵢ/2^{hi} to the element of the result matrix to which it belongs.

### Example

Suppose the given vector is V=[3, 7, 2, 12, 8, 6]
After dividing powers of two, the V=:
   [3, 7, 1, 3, 1, 3]
      When sorting and eliminating duplicates, the resulting vector S=[1, 3, 7]. The vector of pointers is P=[2, 3, 1, 2, 1, 2]. For instance, the first element of vector V, which is 3, appears in position 2 of S. The fourth element of V, which is 12, has also become 3 after removing factors of 2, so the fourth element of P is also 2. The vector H that records the number of positions shifted is H=[0, 0, 1, 2, 3, 1]. For example, the 3 in V is not shifted at all, while the 12 in V has been shifted two positions to the right.

There are two advantages to this alignment step. First, it reduces the number of elements of vector V that are considered distinct. Thus, it reduces the length of the sorted list and the length of the vector of differences. But it has another more subtle effect. The elements of the sorted list are all odd. Therefore, all differences other than the first are even. Thus, when called recursively the first time, differences have at most b 1 bits after shifting right to eliminate trailing zeroes.

Also, a second improvement/modification can be implemented to the vector-scalar multiplication algorithm depicted in FIG. 1. Specifically, this modification takes advantage of zeros, ones, and duplicates in the columns of the first matrix. The vector-scalar multiplication algorithm depicted in FIG. 1 takes a column of the first matrix, and processes each of its n values independently. However, if there are duplicates among those values, duplicates can first be eliminated. Further, nothing is done for those values that are 0. Also, for values that are 1, no multiplication is needed; the original vector V can be taken as the product.

The technique described earlier regarding alignment can also be used here to the columns of the first matrix. Referring back to the example described in the earlier discussion about alignment, if 3 and 12 are both elements of a column, and 3V is computed, then 12V does not need to be computed. The values of the vector 3V can simply be shifted two positions left.

Ideally, as much of the circuitry on a chip should be active at any given time. The algorithm as described in FIG. 1 may be considered first as a serial algorithm for a chip. However, there are many opportunities to increase the parallelism in the chip. First, note that other than the circuit to sort, which itself can be parallelized in known ways, most of the components needed are either registers to store the various vectors needed, or adder circuits. Moreover, as described in FIG. 1, all the vectors shown are handled or managed with a single adder circuit.

The vector V can be multiplied by many different scalars c at the same time, registers may be needed to store intermediate results for each c. That change may thus speed up the time needed by a large factor. Likewise, different rows of the vector V may be processed in parallel, which also speeds up the process.

There is one modification to the algorithm that will increase the ratio of adder space to register space. After sorting and eliminating duplicates, the sorted vector S can be segmented or broken into several segments: one segment for the smallest values, another for the next smallest values, and so on. Then each segment can be processed independently, in parallel. That change allows one to use many adders at once to accumulate differences for a single vector S. A significant reduction in the total length of vectors is expected after taking the second differences.

A second approach is to divide a vector of length n into square root of n segments of length square root of n each. Accumulate the sum within each segment. Then, accumulate the sums of the final sum of each segment, to get the value that must be added to each member of each segment. That is, each element of the ith segment the sum of the last elements in each of the segments 1 through i-1. This approach gives square root of n-fold parallelism, while requiring 2n+square root of n additions in place of the n additions that would be needed to do a sequential accumulation of all n elements.

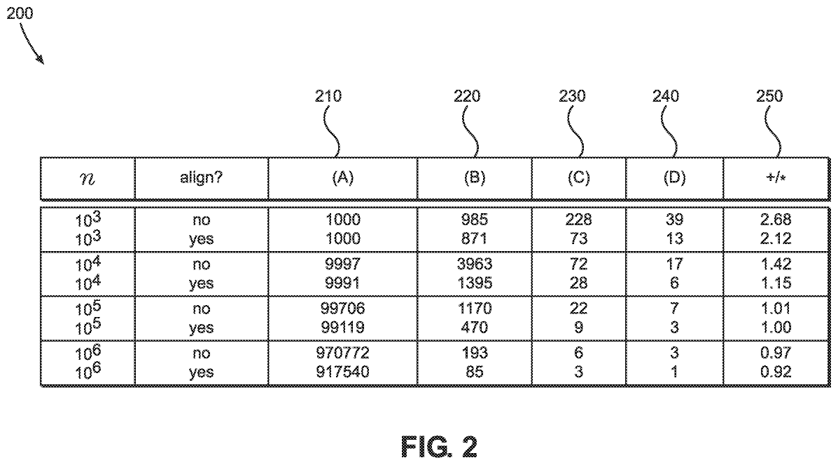

Turning now to FIG. 2, FIG. 2 shows a table 200 of the lengths of the lists that result from certain experiments utilizing the vector-matrix multiplication algorithm of FIG. 1. For four values of n ranging from one thousand to one million, 100 lists of random 24-bit numbers are generated. These lists are then sorted, and duplicates are eliminated. In some cases, the numbers are right-shifted (aligned) first to eliminate factors of 2. The lengths of the resulting sorted lists are shown in Column A 210. Column A and the following columns are averages rounded to the nearest integer.

Column B 220 shows the lengths of the lists after taking differences and performing the same operations on the list of differences—align (if permitted), sort, and eliminate duplicates. Then, column C 230 and Column D 240 represent the lengths of the lists that result after repeating this operation twice more. The last column 250 gives the average number of additions that would be needed to multiply the initial vector of length n by a scalar. To be precise, it is 12 times Column D 240, for the Russian-peasants multiplication of each element on the list of third differences, plus Column A 210, column B 220, and column C 230, all divided by n.

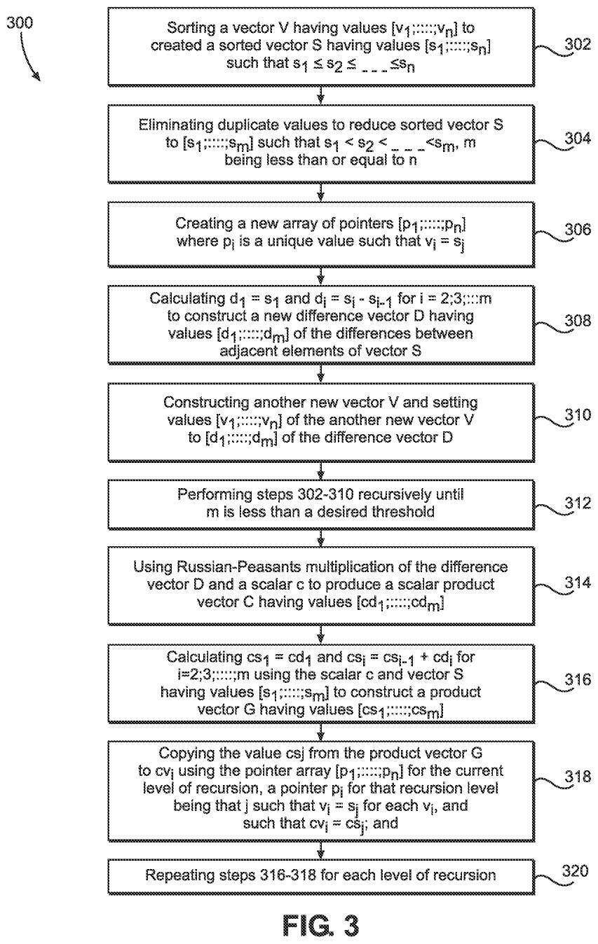

FIG. 3 is a flowchart of an exemplary method 300 of the present disclosure. FIG. 3 may be understood in the context of FIG. 1, which provides a visual overview of certain embodiments of the vector-scalar matrix multiplication described herein.

The method 300 can include a step 302 of sorting, by a special purpose integrated circuit, a vector V having values [v1; : : : ; vn] to create a sorted vector S having values [s1; : : : ; sn] such that s1≤s2≤_ _ _≤sn. Next, the method 300 includes a step 304 of eliminating, by the special purpose integrated circuit, duplicate values to reduce sorted vector S to [s1; : : : ; sm] such that s1<s2<_ _ _<sm, m being less than or equal to n.

The method 300 also includes a step 306 of creating, by the special purpose integrated circuit, a new array of pointers [p1; : : : ; pn] where pi is a unique value j such that vi=sj. In some embodiments, the array of pointers [p1; : : : ; pn] is stored by the special purpose integrated circuit in inverted order. Inverted (reversed) order may make it more efficient for storing the array of pointers, since for each i, there would be easier access to all the values of j for which vj=si in this step.

Further, the method can also include a step 308 of calculating d1=s1 and di=si−si−1 for i=2; 3; : : :m to construct a difference vector D having values [d1; : : : ; dm] of the differences between adjacent elements of vector S. The method 300 further includes a step 310 constructing another new vector V and setting values [v1; : : : ; vn] of the another new vector V to [d1; : : : ; dm] of the difference vector D. Then, in step 312, steps 302, 304, 306, 308, and 310 are performed recursively until m is less than a desired threshold. In some embodiments, the desired threshold is 4; however, the present technology is not limited to just having a desired threshold of 4. The desired threshold can be any numerical value.

The method 300 further includes step 314 of using Russian-Peasants multiplication, by the special purpose integrated circuit, of the difference vector D and a scalar c to produce a scalar product vector C having values [cd1; : : : ; cdm]. The method 300 continues with step 316 of calculating, by the special purpose integrated circuit, d1=s1 and di=si−si−1 for i=2; 3; : ::m to construct a new difference vector D having values [d1; : : : ; dm] of the differences between adjacent elements of vector S.

The method 300 further includes step 318 of copying, by the special purpose integrated circuit, the value csj from the product vector G to cvi using the pointer array [p1; : : : ; pn] for the current level of recursion, a pointer pi for that recursion level being that j such that vi=sj for each vi, and such that cvi=csj.

The method 300 continues by repeating steps 316 and 318 for each level of recursion. The method 300 may include an optional step of producing and storing results in a memory associated with the special purpose integrated circuit. The method 300 may also include a step of sorting, by the special purpose integrated circuit, the array of pointers [p1; : : : ; pn]. Furthermore, the method 300 can include the optional step of segmenting the sorted vector S into a plurality of segments, so that each segment is processed in parallel independently to accumulate differences for the sorted vector S, which equates to highly efficient parallel execution.

As previously mentioned, a special purpose integrated circuit for implementing vector-scalar multiplications between a vector and a scalar can be constructed to perform mathematical operations that are described in the method 300 of FIG. 3 or in the context of FIG. 1. In some embodiments, the special purpose integrated circuit includes a single adder circuit. The single adder circuit can manage the vector V, the sorted vector S, the difference vector D, the scalar product vector C, the another new vector V, and the product vector G. In other embodiments, the special purpose integrated circuit includes a plurality of adder circuits, which can manage the vectors described in the steps of the method 300.

The special purpose integrated circuit may also have the capability of sorting and/or storing the array of pointers [p1; : : : ; pn] which are used in the method 300, as described above. In some embodiments, the special purpose integrated circuit is further configured to produce and store one or more results of the mathematical operations in a memory that is associated with the special purpose integrated circuit.

In some embodiments, the special purpose integrated circuit can be utilized by any computing system, including but not limited to, a machine learning system or a neural network. Also, the special purpose integrated circuit can be configured to perform aspects of the method 300 in parallel execution. For instance, the parallel execution may include processing in parallel a plurality of rows of the vector V of the method 300. Another instance of parallel execution that can be performed by the special purpose integrated circuit is described earlier herein, where the method 300 can include the optional step of segmenting the sorted vector S into a plurality of segments, so that each segment is processed in parallel independently to accumulate differences for the sorted vector S.

Furthermore, referring back to the step 306 of FIG. 3, the special purpose integrated circuit can be configured to store the array of pointers [p1; : : : ; pn] in inverted order. Inverted (reversed) order may make it more efficient for storing the array of pointers, since for each i, there would be easier access to all the values of j for which vj=si in the step 306 of the method 300 (FIG. 3)

### Example Use Cases

As mentioned earlier, there are a multitude of practical and technical applications for matrix multiplication by addition, particularly in the computing world. For instance, machine learning systems and programming can be improved using the embodiments described in the present disclosure. In particular, large datasets can be represented by large matrices. If traditional matrix multiplication algorithms are utilized, the computations for large matrices require a lot of chip space and more importantly, a much longer time to complete the matrix multiplication. With the present disclosure, with matrix multiplication by addition, the computations for large matrices occur more quickly and efficiently, so that machine learning can occur faster with reliable results.

In another use case, for video gaming and robotics, matrix multiplication by addition as described in the present disclosure can enable a faster computation of three-dimensional coordinates into 2-dimensional coordinates. For example, avatars or characters in a video game may be rotated, swiveled, or otherwise manipulated by a gaming user's device, such that the rendering appears to be in real time or near real time with the gaming user's device controls. In essence, matrix multiplication by addition can exponentially enhance the gaming user's experience since both the quality and the efficiency of the timing of the image rendering will be improved.

In yet another use case, graphics software will benefit from matrix multiplication by addition, because again, the quality and the efficiency of the timing of image rendering will be vastly improved. In yet other use cases, medical imaging scans may also be similarly improved.

Furthermore, any computing system or technology that requires matrix transformations can benefit from the new approach described in the present disclosure. This includes audio and visual applications, including but not limited to, streaming video and music, which require complex matrix-based mathematical computations to provide clear audible sounds and sharp visual images. Also, cryptography, for encrypting and decrypting data, files and messages, is based on matrix transformations, and therefore the area of cryptography can benefit from this new approach.

Also, coordinate-based systems are another use case for matrix multiplication by addition. For instance, geographical mapping systems, tracking systems (of objects and/or people), aviation systems, and the like all require quick computations and transformations of matrices in order to provide their services.

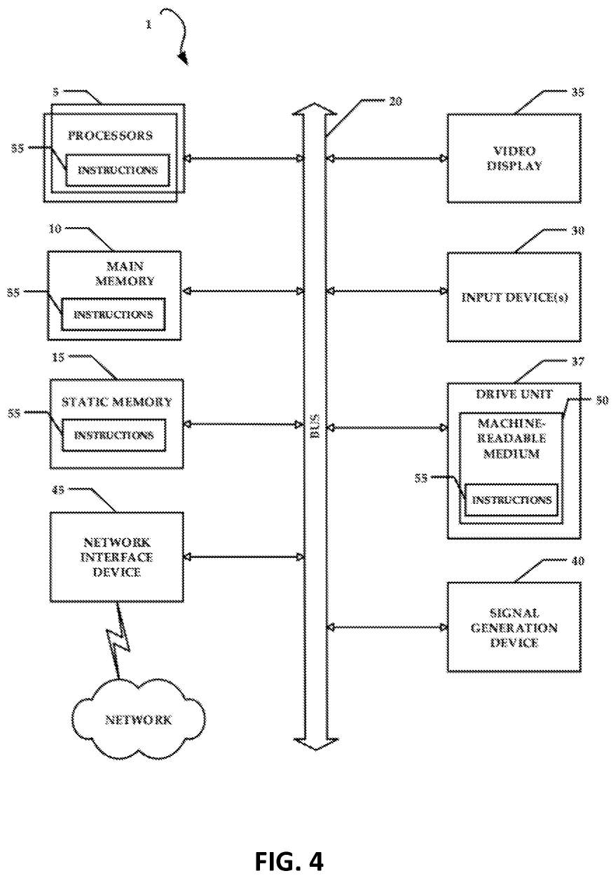

FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and/or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on.” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A special purpose integrated circuit for implementing vector-scalar multiplications between a vector and a scalar, the special purpose integrated circuit constructed to perform mathematical operations comprising:
a) sorting a vector V having values [v1; : : : ; vn] to create a sorted vector S having values [s1; : : : ; sn] such that s1≤s2≤_ _ _≤sn;
b) eliminating duplicate values to reduce the sorted vector S to [s1; : : : ; sm] such that s1<s2<_ _ _<sm, m being less than or equal to n;
c) creating an array of pointers [p1; : : : ; pn] where pi is a unique value j such that vi=sj;
d) calculating d1=s1 and di=si−si−1 for i=2; 3; : : :m to construct a difference vector D having values [d1; : : : ; dm] of the differences between adjacent elements of the sorted vector S;
e) constructing another new vector V and setting values [v1; : : : ; vn] of the another new vector V to [d1; : : : ; dm] of the difference vector D;
f) performing steps a-e recursively until m is less than a desired threshold;
g) using Russian-Peasants multiplication of the difference vector D and a scalar c to produce a scalar product vector C having values [cd1; : : : ; cdm];
h) calculating cs1=cd1 and csi=csᵢ₋₁+cdi for i=2; 3; : : : ; m using the scalar c and vector S having values [s1; : : : ; sm] to construct a product vector G having values [cs1; : : : ; csm];
j) copying the value csj from the product vector G to cvi using the array of pointers [p1; :: : ; pn] for a current level of recursion, a pointer pi for the current level of recursion being that j such that vi=sj for each vi, and such that cvi=csj; and
k) repeating steps h-j for each level of recursion.

2. The special purpose integrated circuit of claim 1, comprising a single adder circuit.

3. The special purpose integrated circuit of claim 2, wherein the single adder circuit is configured to manage the vector V, the sorted vector S, the difference vector D, the scalar product vector C, the another new vector V, and the product vector G.

4. The special purpose integrated circuit of claim 1, wherein the special purpose integrated circuit is further configured to sort the array of pointers [p1; : : : ; pn].

5. The special purpose integrated circuit of claim 1, wherein the special purpose integrated circuit is further configured to produce and store one or more results of the mathematical operations in a memory that is associated with the special purpose integrated circuit.

6. The special purpose integrated circuit of claim 1, wherein the special purpose integrated circuit is utilized by a machine learning system.

7. The special purpose integrated circuit of claim 1, wherein the special purpose integrated circuit is utilized by a neural network.

8. The special purpose integrated circuit of claim 1, wherein the special purpose integrated circuit is configured for parallel execution.

9. The special purpose integrated circuit of claim 8, wherein the parallel execution comprises processing in parallel a plurality of rows of the vector V.

10. The special purpose integrated circuit of claim 1, wherein the mathematical operations further include segmenting the sorted vector S into a plurality of segments, so that each segment is processed in parallel independently to accumulate differences for the sorted vector S.

11. The special purpose integrated circuit of claim 1, wherein the special purpose integrated circuit is further configured to store the array of pointers [p1; : : : ; pn] in inverted order.

12. A method for implementing vector-scalar multiplications between a vector and a scalar, comprising:
a) sorting, by a special purpose integrated circuit constructed to perform mathematical operations, a vector V having values [v1; : : : ; vn] to create a sorted vector S having values [s1; :: : ; sn] such that s1<≤s2≤_ _ _≤sn;
b) eliminating, by the special purpose integrated circuit, duplicate values to reduce the sorted vector S to [s1; : : : ; sm] such that s1<s2<_ _ _<sm, m being less than or equal to n;
c) creating, by the special purpose integrated circuit, an array of pointers [p1; : : : ; pn] where pi is a unique value j such that vi=sj;
d) calculating, by the special purpose integrated circuit, d1=s1 and di=si−si−1 for i=2; 3; : : :m to construct a new difference vector D having values [d1; : : : ; dm] of the differences between adjacent elements of the sorted vector S;
e) constructing, by the special purpose integrated circuit, another new vector V and setting values [v1; : : : ; vn] of the another new vector V to [d1; : : : ; dm] of the difference vector D;
f) performing steps a-e recursively until m is less than a desired threshold;
g) using Russian-Peasants multiplication, by the special purpose integrated circuit, of the difference vector D and a scalar c to produce a scalar product vector C having values [cd1; : : : ; cdm];
h) calculating, by the special purpose integrated circuit, cs1=cd1 and csi=csi−1+cdi for i=2; 3; : : : ; m using the scalar c and vector S having values [s1; : : : ; sm] to construct a product vector G having values [cs1; : : : ; csm];
j) copying, by the special purpose integrated circuit, the value csj from the product vector G to cvi using the pointer array [p1; : : : ; pn] for a current level of recursion, a pointer pi for the current level of recursion being that j such that vi=sj for each vi, and such that cvi=csj; and
k) repeating steps h-j for each level of recursion.

13. The method of claim 12, wherein the special purpose integrated circuit further comprises a single adder circuit.

14. The method of claim 12, further comprising managing, by the special purpose integrated circuit, the vector V, the sorted vector S, the difference vector D, the scalar product vector C, the another new vector V, and the product vector G.

15. The method of claim 12, further comprising sorting, by the special purpose integrated circuit, the array of pointers [p1; : : : ; pn].

16. The method of claim 12, further comprising producing and storing, by the special purpose integrated circuit, one or more results of the mathematical operations in a memory that is associated with the special purpose integrated circuit.

17. The method of claim 12, wherein the special purpose integrated circuit is utilized by a machine learning system.

18. The method of claim 12, wherein the special purpose integrated circuit is utilized by a neural network.

19. The method of claim 12, wherein the special purpose integrated circuit is configured for parallel execution.

20. The method of claim 19, wherein the parallel execution comprises processing in parallel a plurality of rows of the vector V.

21. The method of claim 12, further comprising segmenting the sorted vector S into a plurality of segments, segmenting the sorted vector S into a plurality of segments, so that each segment is processed in parallel independently to accumulate differences for the sorted vector S.

22. The method of claim 12, further comprising storing, by the special purpose integrated circuit, the array of pointers [p1; : : : ; pn] in inverted order.
